(19) United States
(12) Patent Application Publication
(10) Pub. No.: US 2023/0057285 A1
(43) Pub. Date: Feb. 23, 2023

(54) Prelithiated Anode, Lithium-Ion Battery Containing Same, and Method of Producing Same

(71) Applicant: Global Graphene Group, Inc., Dayton, OH (US)

(72) Inventors: Aruna Zhamu, Springboro, OH (US); Hui He, Dayton, OH (US); Bor Z. Jang, Centerville, OH (US)

(21) Appl. No.: 17/402,188

(22) Filed: Aug. 13, 2021

(51) Int. Cl. H01M 4/36; H01M 4/134; H01M 4/133; H01M 10/0525; H01M 4/587

(52) U.S. Cl. CPC H01M 4/366; H01M 4/134; H01M 4/133; H01M 10/0525; H01M 4/587; H01M 2004/027

(57) ABSTRACT

The disclosure provides a multi-layer prelithiated anode including (a) a conducting substrate having a first primary surface and a second primary surface; (b) a first layer of lithium metal deposited onto the first primary surface of the conducting substrate; (c) a first graphitic layer that substantially covers the first lithium metal layer; and (d) a first anode active layer deposited on a primary surface of the first graphitic layer. The first anode active layer includes an anode active material. Also provided are a lithium battery including such a prelithiated anode and a method of producing such an anode.

### GOVERNMENT RIGHTS

This invention was made with government support under the US Air Force SBIR Program. The US government has certain rights in the invention.

### FIELD

The present disclosure relates generally to the field of lithium-ion batteries and, in particular, to a multi-layer prelithiated anode (negative electrode) for a lithium-ion battery and a method of producing prelithiated anode active material layers.

### BACKGROUND

A unit cell or building block of a lithium-ion battery is typically composed of an anode current collector, an anode or negative electrode layer (also known as an anode active material layer typically containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte; or the separator itself contains a solid-state electrolyte.

The binder in the anode layer is used to bond the anode active material (e.g., graphite or Si particles) and a conductive filler (e.g., carbon black or carbon nanotube) together to form an anode layer of structural integrity, and to bond the anode layer to an anode current collector, which acts to collect electrons from the anode active material when the battery is discharged. In other words, in the negative electrode (anode) side of the battery, there are typically four different materials involved: an anode active material, a conductive additive, a resin binder (e.g., polyvinylidine fluoride, PVDF, or styrene-butadiene rubber, SBR), and an anode current collector (typically a sheet of Cu foil). Typically, the former three materials form a separate, discrete anode active material layer that is bonded to the latter one (Cu foil). In some cases, a Cu foil can be deposited with two anode active material layers on the two primary surfaces of the Cu foil.

The most commonly used anode active materials for lithium-ion batteries are natural graphite and synthetic graphite (or artificial graphite) that can be intercalated with lithium and the resulting graphite intercalation compound may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the purpose of the charge transfer between an anode and a cathode. As the SEI is formed, the lithium ions become part of the inert SEI layer and become irreversible, i.e. these positive ions can no longer be shuttled back and forth between the anode and the cathode during subsequent charges/discharges. Therefore, it is desirable to use a minimum amount of lithium for the formation of an effective SEI layer. In addition to SEI formation, the irreversible capacity loss [symbol] ᵢᵣ can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film must have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g., up to a volume expansion of 380%) during the battery charge step, the protective coating is easily broken due to the mechanical weakness and/o brittleness of the protective coating materials. There has been no high-strength and high-toughness material available that is itself also lithium ion conductive.

The prior art protective materials all fall short of these requirements. Hence, it is not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g., those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, polymeric carbon, amorphous carbon, or pre-graphitic carbon may have too many lithium-trapping sites that irreversibly capture lithium during the first few cycles, resulting in excessive irreversibility.

Prelithiation of silicon is an effective way to alleviate the issues associated with the large volume expansion and rapid capacity decay for silicon anodes. Prelithiation involves intercalating lithium ions into the silicon prior to subjecting the electrode or a cell to a charging cycle. Known methods of prelithiation can involve dipping a web of electrochemically active material, prior to forming an electrode therefrom, in an organic salt while running a current through the web. One example is based on one of our earlier patents: Aruna Zhamu and Bor Z. Jang, “Surface-Stabilized and Prelithiated Anode Active Materials for Lithium Batteries and Production Method,” U.S. Pat. No. 10,256,459 (Apr. 9, 2019). Other methods of prelithiation involve directly contacting electrochemically active material with lithium metal, or depositing lithium metal directly onto the active material, for example via a vapor deposition or sputtering process.

S. J. Deng, et al. (US Publication No. 20210104740, Published on Apr. 8, 2021) disclosed a method of prelithiating a silicon-containing electrode in the form of an electrode roll. The method includes (a) electrically connecting the silicon-containing electrode to a negative terminal of an electrical power source; (b) immersing the silicon-containing electrode in a lithium salt solution; wherein a lithium source is immersed in the lithium salt solution such that it does not directly contact the silicon-containing electrode and the lithium source is electrically connected to a positive terminal of the electrical power source; and (c) applying a current from the electrical power source to the silicon-containing electrode for a duration until a desired level of lithium intercalation of the silicon-containing electrode is achieved.

This disclosure suggests that the desired level of lithium intercalation (or degree of prelithiation) is from 10% to 40%, which is not sufficient for the lithiated anode material (i.e., Si particles) to serve as a lithium source in the lithium-ion cells wherein the cathode is lithium-free when the cell is made. Examples of lithium-free cathode active materials are TiS₂, TaS₂, MoS₂, NbSe₃, MnO₂, CoO₂, an iron oxide, a vanadium oxide, CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and most of the organic and organometallic cathode materials. Many of these initially lithium-free cathode active materials are capable of storing more lithium than existing lithium transition metal oxide-based cathode materials. However, Si particles that are fully prelithiated can undergo a 380% volume expansion, thereby damaging or disintegrating the pre-fabricated anode electrode. A strong need exists for a method capable of prelithiating a pre-fabricated anode to its full capacity without damaging the electrode.

There is an urgent and continuing need for a new anode active material layer that enables a lithium-ion battery to exhibit a high cycle life, high reversible capacity, low irreversible capacity, and compatibility with commonly used electrolytes. There is also a need for a method of readily or easily producing such an anode in large quantities.

Thus, it is a specific object of the present disclosure to meet these needs and address the issues associated the rapid capacity decay of a lithium battery containing a high-capacity anode active material.

### SUMMARY

The present disclosure provides a multi-layer prelithiated anode for a lithium-ion cell, the anode including: (a) a conducting substrate having a first primary surface and a second primary surface; (b) a first layer of lithium metal deposited onto the first primary surface of the conducting substrate; (c) a first graphitic layer that substantially covers the first lithium metal layer; and (d) a first anode active layer deposited on a primary surface of the first graphitic layer, wherein the first anode active layer includes an anode active material.

In certain embodiments, the first anode active layer in the multi-layer prelithiated anode includes multiple particles of an anode active material, an optional conductive additive (e.g., carbon black, carbon nanotubes or CNTs, etc.), and a first binder that holds the multiple anode material particles and the conductive additive together to form the first anode active layer. Such an anode active layer may be produced using a traditional anode producing procedure, such as slurry coating or lamination. Alternatively, the first anode active layer includes a film including the anode active material (e.g., a Si layer obtained via chemical vapor deposition, CVD, from a silane gas).

In certain embodiments, the anode active material is selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium niobate, lithium transition metal oxide; (f) carbon or graphite particles; and (g) combinations thereof. Preferably, the anode active material is selected from silicon (Si), germanium (Ge), phosphorus (P), tin (Sn), SiOx (0<x<2.0), SnO₂, or a combination thereof.

In certain embodiments, the first graphitic film includes a film, paper, or fabric layer of a graphene material, expanded graphite, recompressed exfoliated graphite, highly oriented pyrolytic graphite, polymer- or pitch-derived graphite, carbon nanotubes, carbon nano-fibers, carbon or graphite fibers, graphitic carbon, amorphous carbon, or a combination thereof.

The graphene material includes a material selected from pristine graphene, graphene oxide, reduced graphene oxide, graphene fluoride, graphene chloride, graphene bromide, graphene iodide, nitrogenated graphene, hydrogenated graphene, functionalized graphene, doped graphene, or a combination thereof.

In certain embodiments, the conducting substrate is selected from a solid metal film (e.g., foil of Cu, Ni, or stainless steel), a porous metal film (e.g., perforated metal foil or foam), a graphitic film, or a combination thereof wherein the graphitic film includes a film, paper, or fabric of a graphene material, expanded graphite, recompressed exfoliated graphite, highly oriented pyrolytic graphite, polymer- or pitch-derived graphite, carbon nanotubes, carbon nano-fibers, carbon or graphite fibers, graphitic carbon, amorphous carbon, or a combination thereof.

The conducting substrate can play the role of an anode current collector. There can be a terminal tab that is connected to or integral with this current collector. The conducting substrate can also serve as a protective layer for the lithium metal layer. This lithium metal layer is sandwiched between this conducting substrate and the first graphitic layer.

In some embodiments, the conducting substrate includes a thin film, paper, or fabric layer of a graphene material or a composite material including multiple sheets of a graphene material dispersed in a polymer or metal matrix, wherein the graphene material is selected from pristine graphene, graphene oxide, reduced graphene oxide, graphene fluoride, graphene chloride, graphene bromide, graphene iodide, nitrogenated graphene, hydrogenated graphene, functionalized graphene, doped graphene, or a combination thereof.

Preferably, the conducting substrate includes a thin solid film or porous layer of copper (Cu), nickel (Ni), or stainless steel having a thickness from 1 to 50 μm.

The multi-layer prelithiated anode may further include (e) a second layer of lithium metal deposited onto the second primary surface of the conducting substrate; (f) a second graphitic layer that substantially covers the second lithium metal layer; and (g) a second anode active layer deposited on a primary surface of the second graphitic layer.

In certain embodiments, the first and/or the second lithium metal layer contains a lithium amount sufficient to prelithiated the anode to a level of lithium interaction from 5% to 100% of the maximum lithium storage capacity in the anode active material.

The first and/or the second lithium metal layer preferably has a thickness from 10 nm to 100 μm. Preferably, the conductive substrate has a thickness from 1 to 50 μm. The first graphitic layer preferably has a thickness from 10 nm to 50 μm.

The present disclosure also provides a lithium-ion cell that includes the disclosed multi-layer prelithiated anode, a cathode, a separator that electrically isolates the anode from the cathode, and an electrolyte in ionic communication with the anode and the cathode.

In some embodiments, the anode includes Si that is prelithiated to approximately 60-100% and wherein the cathode includes a cathode active material that is initially lithium-free when the cell is made.

The cathode active material may be selected from an inorganic material, an organic material, a polymeric material, or a combination thereof.

The inorganic material may be selected from a metal oxide, metal phosphate, metal silicide, metal selenide, transition metal sulfide, sulfur, lithium polysulfide, selenium, lithium selenide, or a combination thereof.

The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V, Ti, Al, B, Sn, or Bi; and x+y≤1. Examples of the lithium transition metal oxide- or lithium mixed transition metal oxide-based positive active materials include: Li (M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, Where M is a metal, (e.g. Li(Co_{X}Ni_{1-X})O₂ and Li(Co_{X}Fe_{1-X})O₂), Li_{1-W}(Mn_{X}Ni_{Y}Co_{Z})O₂, (e.g. Li(Co_{X}Mn_{Y}Ni_{(1-X-Y)})O₂, Li(Mn_{1/3}Ni_{1/3}Co_{1/3})O₂, Li(Mn_{1/3}Ni_{1/3}Co_{1/3-X}Mg_{X})O₂, Li(Mn_{0.4}Ni_{0.4}Co_{0.2})O₂, Li(Mn_{0.1}Ni_{0.1}Co_{0.8})O₂), Li_{1-W}(Mn_{X}Ni_{X}Co_{1-2X})O₂, Li_{1-W} Mn_{X}Ni_{Y}CoAl_{W})O₂, Li_{1-W} (Ni_{X}Co_{Y}Al_{Z})O₂, Where W=0-1, (e.g., Li(Ni_{0.8}Co_{0.15}Al_{0.05})O₂), Li_{1-W}(Ni_{X}Co_{Y}M_{Z})O₂, Where M is a metal, Li_{1-W} (Ni_{X}Mn_{Y}M_{Z})O₂, Where M is a metal, Li(Ni_{X}Mn_{Y}Cr_{2-X})O₄, LiM′M″₂O₄, Where M′ and M″ are different metals (e.g., LiMn_{2-Y-Z} Ni_{Y}O₄, LiMn_{2-Y-Z} Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-Z} F_{Z}, Li₂MnO₃) Li_{X}V_{Y}O_{Z}, e.g. LiV₃O₈, LiV₂O₅, and LiV₆O₁₃. This list includes the well-known lithium nickel cobalt manganese oxides (NCM) and lithium nickel cobalt manganese aluminum oxides (NCM), among others.

The metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In certain desired embodiments, the inorganic material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%. In some preferred embodiments, prelithiated anode includes Si that is prelithiated to approximately 60-100% and the cathode includes a cathode active material that is initially lithium-free.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The organic material or polymeric material may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]ₙ), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from Poly[methanetetryl-tetra(thiomethylene)](PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

The organic material may contain a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The disclosure also provides a method of producing the multi-layer prelithiated anode herein disclosed. The method includes: (A) providing a conducting substrate having a first primary surface and a second primary surface; (B) depositing or attaching a first layer of lithium metal onto the first primary surface of the conducting substrate; (C) depositing or attaching a first graphitic layer onto the first lithium metal layer wherein the first graphitic layer substantially covers the first lithium metal layer; and (D) depositing a first anode active layer on a primary surface of the first graphitic layer, wherein the first anode active layer includes an anode active material. Preferably, the method is accomplished by a roll-to-roll or reel-to-reel process.

In some embodiments, step (B) includes a procedure selected from physical vapor deposition, chemical vapor deposition, sputtering, electrochemical deposition or plating, laser ablation-assisted deposition, plasma deposition, powder spraying of lithium, attaching a lithium foil, or a combination thereof. Physical vapor deposition or sputtering of a thin film of lithium or attaching a thin layer of lithium foil is preferred.

Step (C) may include a procedure selected from spraying, casting, coating, printing, laminating, or a combination thereof. For instance, the first graphitic film may be produced by combining multiple graphene sheets and/or expanded graphite flakes or platelets into a form of thin film, paper, or fabric using known processes. One may also re-compress exfoliated graphite worms into a flexible graphite foil. Further, one may thermally carbonize and graphitize a film of aromatic polymer (e.g., polyimide or phenolic resin) or pitch (petroleum or coal tar pitch) into a an artificial graphite film. Furthermore, the production processes of fabric or paper layers from carbon nanotubes, carbon nano-fibers, carbon or graphite fibers, etc. are also known in the art.

Preferably, step (D) includes a procedure selected from spraying, casting, coating (e.g., the commonly used slurry coating for fabrication of anodes and cathodes in the lithium-ion battery industry), printing, laminating, physical vapor deposition, chemical vapor deposition, sputtering, electrochemical deposition or plating, laser ablation-assisted deposition, plasma deposition, or a combination thereof.

In the prelithiated anode, the conductive additive may be selected from carbon black, acetylene black, graphene, carbon particles, graphite flakes, carbon nanotubes, carbon fibers, needle coke, amorphous carbon, conducting polymer, metal, conductive composite, or a combination thereof. The graphene may be selected from pristine graphene, graphene fluoride, graphene chloride, graphene bromide, graphene iodide, nitrogenated graphene, hydrogenated graphene, doped graphene, chemically functionalized graphene, a combination thereof, or a combination thereof with graphene oxide or reduced graphene oxide.

In step (D) of fabricating an anode active layer, one may choose to use CVD to deposit a layer of the anode active material (e.g., Si, Ge, etc.) on a primary surface of the graphitic layer prepared in step (C).

In some preferred embodiments, step (D) is conducted prior to step (C). In other words, the first anode active layer may be deposited on a primary surface of the first graphitic layer to form a two-layer structure (e.g., via slurry coating or CVD, as described above). This is followed by attaching the two-layer structure to the first lithium metal layer with the first graphitic layer coming in physical contact with the first lithium metal layer preferably in such a manner that the first graphitic layer substantially covers the first lithium metal layer.

### BRIEF DESCRIPTION OF THE DRAWINGS

FIG. 1(A) Schematic of a multi-layer prelithiated anode according to some embodiments of the present disclosure;

FIG. 1(B) Schematic of a lithium battery cell including a multi-layer prelithiated anode according to some embodiments of the present disclosure;

FIG. 1(C) Schematic of a multi-layer prelithiated anode according to some embodiments of the present disclosure;

FIG. 1(D) Schematic of lithium battery cells including a multi-layer prelithiated anode according to some embodiments of the present disclosure.

FIG. 2(A) Schematic illustrating the notion that expansion of Si particles, upon lithium intercalation during charging of a prior art lithium-ion battery, can lead to pulverization of Si particles, interruption of the conductive paths formed by the conductive additive, and loss of contact with the current collector;

FIG. 2(B) illustrates the issues associated with the prior art anode active material; for instance, a non-lithiated Si particle encapsulated by a protective shell (e.g., carbon shell) in a core-shell structure inevitably leads to breakage of the shell and that a pre-lithiated Si particle encapsulated with a protective layer leads to poor contact between the contracted Si particle and the rigid protective shell during battery discharge.

FIG. 3(A) Schematic of a process for producing graphene films containing an aggregate/cluster of oriented/aligned graphene sheets, according to certain embodiments of the disclosure.

FIG. 3(B) Schematic of a process for producing graphitic films from polymer or pitch films, according to certain embodiments of the disclosure.

FIG. 4(A) Schematic of a process for producing a multi-layer prelithiated anode electrode in a roll-to-roll manner, according to some embodiments of the present disclosure.

FIG. 4(B) Schematic of another process for producing a multi-layer prelithiated anode electrode in a roll-to-roll manner, according to some embodiments of the present disclosure.

FIG. 5 Chemical reactions involved in the production of PBO.

FIG. 6 Capacity decay curves of a lithium-ion cell featuring a prelithiated Si-based anode and a control cell featuring a Si0based anode without prelithiation.

### DETAILED DESCRIPTION OF PREFERRED EMBODIMENTS

A lithium-ion battery cell is typically composed of an anode current collector (e.g., Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, Si, or SiOx, where 0<x<2), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

The anode current collector may be coated with one anode active material layer on one primary surface or two anode active material layers on the two primary surfaces of a current collector. The term “anode” or “negative electrode” refers to the laminate composed of a current collector and one or two anode active material layers bonded thereto. The term anode can refer to an anode active material layer, particularly if there is no anode current collector.

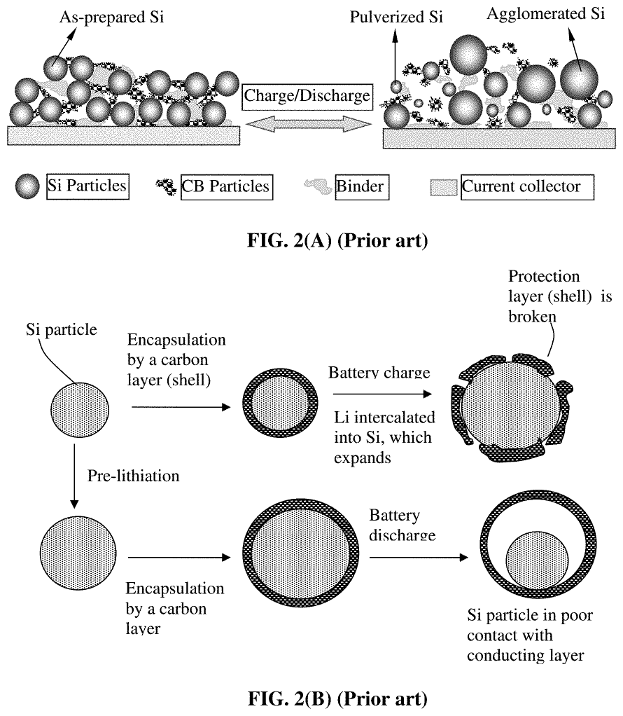

In order to obtain a higher energy density cell, the anode can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). Each and every one of these anode active materials has a maximum lithium ion or charge storage capacity (e.g., 1,623 mAh/g for Ge). However, as discussed in the Background section, there are several problems associated with the implementation of these high-capacity anode active materials:
1) As schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.
2) The approach of using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles, has failed to overcome the capacity decay problem. Presumably, the protective matrix provides a constraining effect for particle expansion or shrinkage, and prevents the electrolyte from contacting and reacting with the electrode active material. Unfortunately, when an active material particle, such as Si particle, expands (e.g. up to a volume expansion of 380%) during the battery charge step, the protective coating is easily broken due to the mechanical weakness and/or brittleness of the protective coating materials. There has been no high-strength and high-toughness material available that is itself also lithium ion conductive.
3) The approach of using a core-shell structure (e.g., Si nano particle encapsulated in a carbon or SiO₂ shell) also has not solved the capacity decay issue. As illustrated in upper portion of FIG. 2(B), a non-lithiated Si particle can be encapsulated by a carbon shell to form a core-shell structure (Si core and carbon or SiO₂ shell in this example). As the lithium-ion battery is charged, the anode active material (carbon- or SiO₂-encapsulated Si particle) is intercalated with lithium ions and, hence, the Si particle expands. Due to the brittleness of the encapsulating shell (carbon), the shell is broken into segments, exposing the underlying Si to electrolyte and subjecting the Si to undesirable reactions with electrolyte during repeated charges/discharges of the battery. These reactions continue to consume the electrolyte and reduce the cell's ability to store lithium ions.
4) Referring to the lower portion of FIG. 2(B), wherein the Si particle has been pre-lithiated with lithium ions; i.e., has been pre-expanded in volume. When a layer of carbon (as an example of a protective material) is encapsulated around the pre-lithiated Si particle, another core-shell structure is formed. However, when the battery is discharged and lithium ions are released (de-intercalated) from the Si particle, the Si particle contracts, leaving behind a large gap between the protective shell and the Si particle. Such a configuration is not conducive to lithium intercalation of the Si particle during the subsequent battery charge cycle due to the gap and the poor contact of Si particle with the protective shell (through which lithium ions can diffuse). This would significantly curtail the lithium storage capacity of the Si particle particularly under high charge rate conditions.

In other words, there are several conflicting factors that must be considered concurrently when it comes to the design and selection of an anode active material in terms of material type, shape, size, porosity, electrode layer thickness, anode binder, and anode material prelithiation. Conventional strategies for prelithiating the anode particles or the anode electrode have also fallen short of addressing the rapid cycle decay issues. Thus far, there has been no effective solution offered by any prior art teaching to these conflicting problems. We have solved these challenging issues that have troubled battery designers and electrochemists alike for more than 30 years by developing the multi-layer prelithiated anode electrodes further described below.

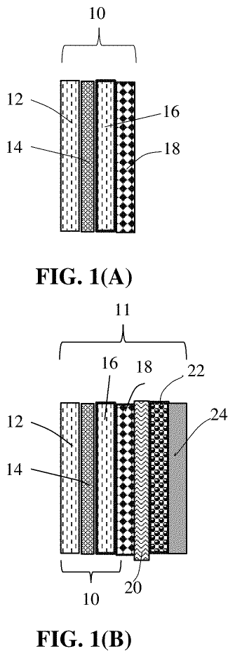

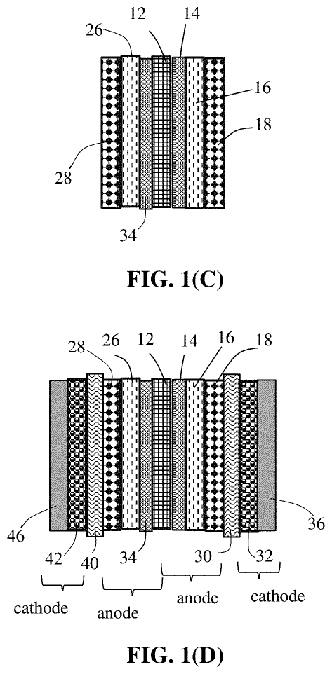

As illustrated in FIG. 1(A) as an example, the present disclosure provides a multi-layer prelithiated anode 10 for a lithium-ion cell, the anode including: (a) a conducting substrate 12 having a first primary surface and an opposite, substantially parallel second primary surface; (b) a first layer of lithium metal 14 deposited onto or attached to the first primary surface of the conducting substrate; (c) a first graphitic layer 16 that substantially covers the first lithium metal layer; and (d) a first anode active layer 18 deposited on a primary surface of the first graphitic layer, wherein the first anode active layer includes an anode active material.

As illustrated in FIG. 1(B), such an anode 10 can be combined with a porous separator or ion-conducting membrane 20, a cathode (e.g., including a cathode active layer 22 supported on a cathode current collector 24, such as an aluminum foil), and an electrolyte (not shown) to form a lithium battery cell 11.

In certain embodiments, the first anode active layer 18 in the multi-layer prelithiated anode includes multiple particles of an anode active material, an optional conductive additive (e.g., carbon black, carbon nanotubes or CNTs, etc.), and a first binder that holds the multiple anode material particles and the conductive additive together to form the first anode active layer. Such an anode active layer may be produced using a traditional anode producing procedure, such as slurry coating or lamination. Alternatively, the first anode active layer includes a film including the anode active material (e.g., a Si layer obtained via chemical vapor deposition, CVD, from a silane gas).

In certain embodiments, the anode active material is selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium niobate, lithium transition metal oxide; (f) carbon or graphite particles; and (g) combinations thereof. Preferably, the anode active material is selected from silicon (Si), germanium (Ge), phosphorus (P), tin (Sn), SiOx (0<x<2.0), SnO₂, or a combination thereof.

In certain embodiments, the first graphitic film 16 includes a film, paper, or fabric layer of a graphene material, expanded graphite, recompressed exfoliated graphite, highly oriented pyrolytic graphite, polymer- or pitch-derived graphite, carbon nanotubes, carbon nano-fibers, carbon or graphite fibers, graphitic carbon, amorphous carbon, or a combination thereof.

The graphene material includes a material selected from pristine graphene, graphene oxide, reduced graphene oxide, graphene fluoride, graphene chloride, graphene bromide, graphene iodide, nitrogenated graphene, hydrogenated graphene, functionalized graphene, doped graphene, or a combination thereof.

In certain embodiments, the conducting substrate 12 is selected from a solid metal film (e.g., foil of Cu, Ni, or stainless steel), a porous metal film (e.g., perforated metal foil or foam), a graphitic film, or a combination thereof wherein the graphitic film includes a film, paper, or fabric of a graphene material, expanded graphite, recompressed exfoliated graphite, highly oriented pyrolytic graphite, polymer- or pitch-derived graphite, carbon nanotubes, carbon nano-fibers, carbon or graphite fibers, graphitic carbon, amorphous carbon, or a combination thereof.

The conducting substrate can play the role of an anode current collector. There can be a terminal tab that is connected to or integral with this current collector. The conducting substrate can also serve as a protective layer for the lithium metal layer. This lithium metal layer is sandwiched between this conducting substrate and the first graphitic layer.

In some embodiments, the conducting substrate includes a thin film, paper, or fabric layer of a graphene material or a composite material including multiple sheets of a graphene material dispersed in a polymer or metal matrix, wherein the graphene material is selected from pristine graphene, graphene oxide, reduced graphene oxide, graphene fluoride, graphene chloride, graphene bromide, graphene iodide, nitrogenated graphene, hydrogenated graphene, functionalized graphene, doped graphene, or a combination thereof.

Preferably, the conducting substrate includes a thin solid film or porous layer of copper (Cu), nickel (Ni), or stainless steel having a thickness from 1 to 50 μm.

As illustrated in FIG. 1(C), the multi-layer prelithiated anode may further include (e) a second layer of lithium metal 34 deposited onto the second primary surface of the conducting substrate 12; (f) a second graphitic layer 26 that substantially covers the second lithium metal layer 34; and (g) a second anode active layer 28 deposited on a primary surface of the second graphitic layer 26.

The anode electrode, including two anode active layers (18, 28), as depicted in FIG. 1(C), may be combined with two cathode active layers (32, 42), two cathode current collectors (36, 46), and two separators (30, 40) to form substantially two battery cells, as illustrated in FIG. 1(D).

In certain embodiments, the first and/or the second lithium metal layer contains a lithium amount sufficient to prelithiated the anode to a level of lithium interaction from 5% to 100% of the maximum lithium storage capacity in the anode active material.

The first and/or the second lithium metal layer preferably has a thickness from 10 nm to 100 μm. Preferably, the conductive substrate has a thickness from 1 to 50 μm. The first graphitic layer preferably has a thickness from 10 nm to 50 μm.

The present disclosure also provides a lithium-ion cell that includes the disclosed multi-layer prelithiated anode, a cathode, a separator that electrically isolates the anode from the cathode, and an electrolyte in ionic communication with the anode and the cathode.

In some embodiments, the anode includes Si that is prelithiated to approximately 60-100% and wherein the cathode includes a cathode active material that is initially lithium-free when the cell is made.

In the disclosed multi-layer anode, the first or the second graphitic layer may include multiple graphene sheets that are aligned to be substantially parallel to one another, wherein the multiple graphene sheets contain graphene sheets selected from a pristine graphene material having essentially zero % of non-carbon elements, or a non-pristine graphene material having 0.001% to 25% by weight of non-carbon elements wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

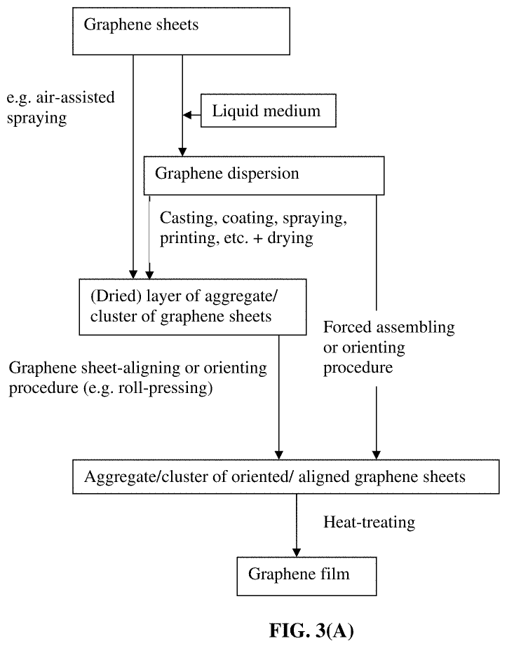

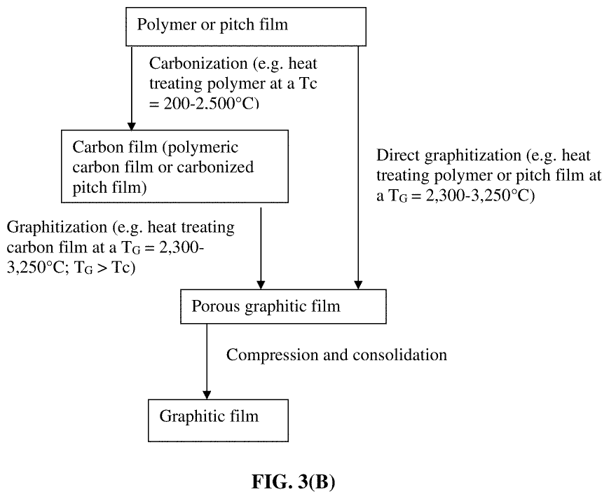

As shown in FIG. 3(A), the graphene films may be produced by simply aggregating and bonding multiple graphene sheets together using a compression or roll-pressing procedure. In certain embodiments, the procedure of forming a layer of an aggregate or cluster of multiple oriented/aligned graphene sheets includes forming a graphene dispersion containing multiple graphene sheets dispersed in a liquid medium, followed by a procedure of forming such a dispersion into a wet layer using a procedure selected from coating, casting, spraying, printing, forced assembling and orienting procedure, or a combination thereof. Such a procedure typically involves removal of the liquid medium to form a dry layer of graphene sheets. This day layer of graphene sheets (pristine graphene, graphene oxide, functionalized graphene sheets, etc.) may be subsequently subjected to a heat treatment at a temperature from 100° C. to 3,000° C. The heat treated layer may then be compressed or roll-pressed to increase the density to 1.6-2.25 g/cm³.

In certain preferred embodiments, the graphene sheets contain mostly single-layer graphene (90% to 100%) having an average number of layers between 1 and 2. In certain embodiments, the graphene sheets contain single-layer graphene and few-layer graphene sheets having an average number of layers less than 5. Few-layer graphene is commonly defined as those graphene sheets having 2-10 layers of graphene planes.

In certain embodiments, the graphene sheets contain a functional group attached thereto to make the graphene sheets exhibit a negative Zeta potential having a value from −55 mV to −0.1 mV.

The graphene sheets may contain a chemical functional group selected from alkyl or aryl silane, alkyl or aralkyl group, hydroxyl group, carboxyl group, epoxide, carbonyl group, amine group, sulfonate group (—SO₃H), aldehydic group, quinoidal, fluorocarbon, or a combination thereof.

In certain embodiments, the graphene sheets contain chemically functionalized graphene sheets having a chemical functional group selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof.

The graphene sheets may contain a chemical functional group selected from OY, NHY, O═C—OY, P═C—NR′Y, O═C—SY, O═C—Y, —CR′1-OY, N′Y or C′Y, and Y is a functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′2—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

In some highly useful embodiments, the graphitic layer is in a thin film form having a thickness from 10 nm to 50 μm and the graphene sheets are substantially aligned parallel to a thin film plane.

The graphitic films can include flexible graphite sheets (flexible graphite foil) including oriented expanded graphite flakes or recompressed expanded graphite worms.

In certain preferred embodiments, the graphitic film may be produced from a film of polymer or pitch, having a film thickness from 10 nm to 100 μm. The process may include subjecting the film to a heat treatment at a carbonization temperature from 300° C. to 1,500° C., followed by a graphitization procedure at a temperature greater than 2000° C. (preferably >2300° C., further preferably >2500° C., and most preferably >2800° C.) in a non-oxidizing atmosphere to graphitize the film for obtaining a porous graphitized film. This porous film is then compressed or roll-pressed to increase the density to 1.5-2.25 g/cm³. In certain embodiments, the non-oxidizing atmosphere contains hydrogen gas, nitrogen gas, inert gas (e.g., He), or a combination thereof.

The starting polymer film for carbonization and graphitization is preferably selected from the group consisting of polyimide, polyamide, phenolic resin, polyoxadiazole, polybenzoxazole, polybenzobisoxazole, polythiazole, polybenzothiazole, polybenzobisthiazole, poly(p-phenylene vinylene), polybenzimidazole, polybenzobisimidazole, poly(pyromellitimide), poly(p-phenylene-isophthalamide), poly(m-phenylene-zoimidazole), poly(phenylene-benzobisimidazole), polyacrylonitrile, and combinations thereof.

In certain embodiments, the pitch film is selected from a film of petroleum pitch, coal tar pitch, a polynuclear hydrocarbon, or a combination thereof. The polynuclear hydrocarbon may be selected from naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

In certain embodiments, as schematically illustrated in FIG. 3(B), a recommended process for producing a graphitic film includes: (a) providing one film of polymer or pitch, having a film thickness no less than 5 nm (preferably from 10 nm to 100 μm, more preferably from 100 nm to 50 μm, further more preferably from 1 to 20 μm); (b) subjecting the at least one film to a heat treatment at a carbonization temperature of T_{C}=200-2,500° C. (more typically 300-1,500° C.) and then a graphitization temperature greater than 2000° C. (preferably >2300° C., further preferably >2500° C., and most preferably >2800° C.) in an non-oxidizing atmosphere to graphitize the film for obtaining a porous graphitized film; and (c) compressing the porous film to produce the graphitic film. Graphitization leads to the formation of graphitic crystals inside the film.

The graphitization treatment may be preceded by a carbonization treatment of the polymer or pitch film, as illustrated in the left-hand side of FIG. 3(B). In other words, the polymer or pitch film is carbonized (e.g., at a carbonization temperature, T_{C}=200-2,500° C.) to obtain a polymeric carbon or carbonized pitch, which is then graphitized at a graphitization temperature, T_{G} (e.g., T_{G}=2,300-3,250° C.; T_{G}>T_{C}). The product of the heat treatment (carbonization and then graphitization or direct graphitization, bypassing the carbonization step) is a porous graphitic film, typically having surface and internal pores. A compression procedure is typically needed to increase the physical density to 1.5-2.2 g/cm³.

In certain embodiments, the anode active layer includes multiple particles of an anode active material, an optional conductive additive, and a first binder that holds the multiple anode material particles and the conductive additive together to form an anode active layer. In some embodiments, the anode includes a film including the anode active material (e.g., CVD Si) deposited on a primary surface of a graphitic layer.

The disclosure also provides a method of producing the multi-layer prelithiated anode herein disclosed. The method includes: (A) providing a conducting substrate having a first primary surface and a second primary surface; (B) depositing or attaching a first layer of lithium metal onto the first primary surface of the conducting substrate; (C) depositing or attaching a first graphitic layer onto the first lithium metal layer wherein the first graphitic layer substantially covers the first lithium metal layer; and (D) depositing a first anode active layer on a primary surface of the first graphitic layer, wherein the first anode active layer includes an anode active material.

In some embodiments, step (B) includes a procedure selected from physical vapor deposition, chemical vapor deposition, sputtering, electrochemical deposition or plating, laser ablation-assisted deposition, plasma deposition, powder spraying of lithium, attaching a lithium foil, or a combination thereof. Physical vapor deposition or sputtering of a thin film of lithium or attaching a thin layer of lithium foil is preferred.

A thin lithium layer can be deposited on the surface of a conductive substrate using a standard thin film process, such as thermal evaporation, electron beam evaporation, sputtering, and laser ablation. A vacuum may be used during the deposition process to avoid reactivity between the atomic lithium and molecules of lithium-reactive substances such as water, oxygen, and nitrogen. A vacuum of greater than 1 milli-Torr is desirable. When electron beam deposition is used a vacuum of 10⁻⁴ Torr is desired and a vacuum of 10⁻⁶ Torr is preferred to avoid interaction between the electron beam and any residual air molecules.

The evaporative deposition techniques involve the heating of a lithium metal to create a lithium vapor. The lithium metal can be heated by an electron beam or by resistive heating of the lithium metal. The lithium vapor deposits lithium onto the conductive substrate. To promote the deposition of lithium metal the conductive substrate can be cooled or maintained at a temperature lower than the temperature of the lithium vapor. A thickness monitor such as a quartz crystal type monitor can be placed near the substrate to monitor the thickness of the film being deposited. Alternatively, laser ablation and sputtering techniques can be used to promote thin lithium film growth on a substrate. For example, argon ions can be used in the sputtering process to bombard a solid lithium metal target. The bombarding knocks lithium off of the target and deposits it on the surface of a substrate. Laser ablation processes can be used to knock lithium off of a lithium target. The separated lithium atoms are then deposited onto the substrate.

Step (C) may include a procedure selected from spraying, casting, coating, printing, laminating, or a combination thereof. For instance, the first graphitic film may be produced by combining multiple graphene sheets and/or expanded graphite flakes or platelets into a form of thin film, paper, or fabric using known processes. One may also re-compress exfoliated graphite worms into a flexible graphite foil. Further, one may thermally carbonize and graphitize a film of aromatic polymer (e.g., polyimide or phenolic resin) or pitch (petroleum or coal tar pitch) into a an artificial graphite film. Furthermore, the production processes of fabric or paper layers from carbon nanotubes, carbon nano-fibers, carbon or graphite fibers, etc. are also known in the art.

Preferably, step (D) includes a procedure selected from spraying, casting, coating (e.g., the commonly used slurry coating for fabrication of anodes and cathodes in the lithium-ion battery industry), printing, laminating, physical vapor deposition, chemical vapor deposition, sputtering, electrochemical deposition or plating, laser ablation-assisted deposition, plasma deposition, or a combination thereof.

In the prelithiated anode, the conductive additive may be selected from carbon black, acetylene black, graphene, carbon particles, graphite flakes, carbon nanotubes, carbon fibers, needle coke, amorphous carbon, conducting polymer, metal, conductive composite, or a combination thereof. The graphene may be selected from pristine graphene, graphene fluoride, graphene chloride, graphene bromide, graphene iodide, nitrogenated graphene, hydrogenated graphene, doped graphene, chemically functionalized graphene, a combination thereof, or a combination thereof with graphene oxide or reduced graphene oxide.

In step (D) of fabricating an anode active layer, one may choose to use CVD to deposit a layer of the anode active material (e.g., Si, Ge, etc.) on a primary surface of the graphitic layer prepared in step (C).

In some preferred embodiments, step (D) is conducted prior to step (C). In other words, the first anode active layer may be deposited on a primary surface of the first graphitic layer to form a two-layer structure (e.g., via slurry coating or CVD, as described above). This is followed by attaching the two-layer structure to the first lithium metal layer with the first graphitic layer coming in physical contact with the first lithium metal layer preferably in such a manner that the first graphitic layer substantially covers the first lithium metal layer.

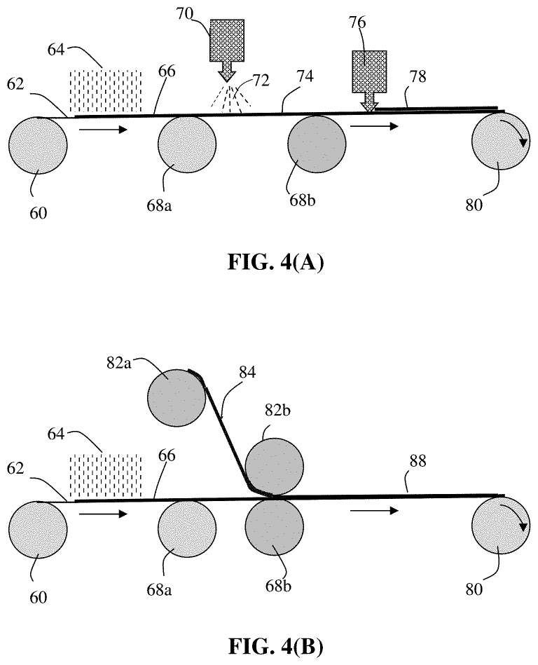

In some preferred embodiments, as schematically illustrated in FIG. 4(A), the method is preferably conducted in a roll-to-roll manner. For instance, the desired process may begin with step (A) of unwinding a conductive substrate 62 (e.g., a Cu foil, a graphene film, or a polymer-derived graphitic film, etc.) from a roll 60. This is followed by step (B), wherein the lithium film depositing may be conducted by using vapor deposition (e.g., 64), sputtering, electron beam deposition, ion implementation, laser ablation, or a combination thereof. The resulting lithium metal-deposited conductive substrate 66, supported on and facilitated by rollers 68a, 68b, is being driven to move forward toward the right-hand side as an example. A sprayer or dispenser 70 is operated to deposit multiple graphene sheets or expanded graphite flakes (with or without an adhesive) to form a graphitic layer 74 onto a primary surface (top surface shown here) of the lithium metal layer. This is followed by operating a slurry coating procedure (e.g., using a coating head 76) to deposit an anode active material layer 78, which is deposited onto the top surface of the lithium metal layer. The resulting multi-layer structure is then collected on a winding roller 80.

The anode active layer 78 may be produced by operating a dispensing/coating device 76 to coat a slurry (including multiple particles of an anode active material, an optional conductive additive, and a first binder resin) onto one primary surface of the lithium metal layer. This is preferably followed by drying to obtain an anode active material layer 78. This can be accomplished by using the conventional slurry coating and drying process, or any well-known process of electrode preparation. The first binder resin holds the multiple anode material particles

Alternatively, as illustrated in FIG. 4(B), a two-layer structure 84, including an anode active layer (top layer) deposited on a graphitic layer (bottom layer), is pre-made and wound on a roller 82a. One may then unwind the two-layer structure from the roller and then laminate this two-layer structure with the lithium metal-coated conductive substrate 66, allowing the graphitic layer to be in contact with the lithium metal layer, using a pair of rollers 68b, 82b. The resulting multi-layer anode structure is then collected on the winding roller 80.

It may be noted that one may choose to bring an electrolyte solution to come in contact with the lithium metal, the first graphitic layer, and the anode active material layer to activate the prelithiation procedure to obtain a fully or partially prelithiated anode active material layer (e.g., 18 in FIG. 1(A)). Alternatively, one may wait until a battery cell is made and a liquid electrolyte is introduced into the cell to activate the prelithiation procedure. With the presence of a liquid electrolyte, the lithium film and the anode active material are made into a short-circuiting situation, enabling lithium to pass through a graphitic layer and then intercalate into the anode active material at a controlled rate. The presence of this first graphitic layer serves to cushion the volume expansion of the interacted anode active material and avoid a violent intercalation procedure that otherwise could occur if the anode active material layer is in direct physical contact with the lithium metal layer.

In some embodiments, an amount or level of prelithiation of an electrode may be defined as the percentage of the anode active material (e.g. silicon) in the pre-fabricated anode electrode that is alloyed with lithium during a prelithiation process. In some embodiments (e.g., for the anode to be paired up with a cathode containing a lithiated or lithium-containing cathode active material, such as LiCoO₂, LiMn₂O₄, NCN, NCA, and LFP), the methods described herein may be able to achieve prelithiation levels of greater than 5%, greater than 10%, greater than 15%, greater than 20%, greater than 25%, or greater. In some embodiments the methods described herein ma y be able to achieve prelithiation levels of about 4%, about 8%, about 12%, about 15%, about 20%, about 25% about 30%, about 35%, about 40%, or any range of values therebetween, for example such as about 10% to about 30%. In some embodiments (e.g., for an anode to work with a non-lithiated cathode active material, such as CoF₃, MnF₃, FeF₃, VF₃, VOF₃, TiF₃, BiF₃, NiF₂, FeF₂, CuF₂, CuF, SnF₂, AgF, CuCl₂, FeCl₃, or MoS₂), the desired level of prelithiation in a silicon-containing electrode may be any percentage from 40% to 100%, preferably greater than 60%, further preferably greater than 80%.

Preferably, the anode is prelithiated to a level of lithium interaction from 40% to 100% of the maximum lithium storage capacity, inducing a volume expansion of the anode active material to an extent of from 10% to 380%.

The lithium salt in the electrolyte may be selected from lithium hydroxide, LiOH, lithium carbonate, Li₂CO₃, lithium halide, LiX (X═F, Cl, B, or I), lithium methoxide, lithium azide, lithium acetate, lithium acetylacetonate, lithium amide, lithium acetylides, R—Li (R=alkyl and aryl), R₃DLi derivatives, where D=Si, Ge, Sn and R=alkyl or aryl, lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium trifluoromethanesulfonimide, LiTFSI, lithium oxalyldifluoroborate (LiODFB), LiPF₃(CF₂CF₃)₃(LiFAP), LiBF₃(CF₂CF₃)₃(LiFAB), LiN(C₂F₅SO₂)₂, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), a lithium salt having a cyclic alkyl group, an ionic liquid-based lithium salt, or a combination thereof. It may be noted that these metal salts are also commonly used in the electrolytes of rechargeable lithium batteries.

The electrolytes for lithiating or for use in a lithium battery cell may contain a solvent selected from any solvent commonly used for an operating lithium ion battery. Examples of non-aqueous solvents suitable for some lithium ion cells include the following: cyclic carbonates (e.g., ethylene carbonate (EC), propylene carbonate (PC), butylene carbonate (BC) and vinylethylene carbonate (VEC)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), fluorinated versions of the cyclic and linear carbonates (e.g., monofluoroethylene carbonate (FEC)), lactones (e.g., gamma-butyrolactone (GBL), gamma-valerolactone (GVL) and alpha-angelica lactone (AGL)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S═O group (e.g., dimethyl sulfone and divinyl sulfone), and combinations thereof.

The aforementioned prelithiation processes are applicable to all of the anode active materials discussed in the present specification, not just Si and graphite, although Si and graphite are used as an example to illustrate the best-mode practice. The anode active material preferably includes silicon and the prelithiated particles include a prelithiated silicon, represented by Li₄Si, Li_{4.4}Si, or LiₓSi, wherein numerical x is between 1 and 4.4. The step of providing an anode active material may include providing a doped semiconductor material. Such a doped semiconductor material may be selected from Si or Ge doped with n-type and/or p-type dopants. Commonly used n-type dopants are P, As, and Sb and commonly used p-type dopants are Al, Ga, and In.

The disclosure also provides a lithium-ion cell including the disclosed prelithiated anode, a cathode including a cathode active material, an ion-permeable separator disposed between the prelithiated anode and the cathode. The cathode may be produced by any known process; e.g., the commonly used slurry coating and drying procedure. There is no restriction on the types of cathode materials or the processes that can be used.

The cathode active material may be selected from an inorganic material, an organic material, a polymeric material, or a combination thereof. In general, in order to make use of a cathode active material having no lithium contained in the cathode material structure (e.g., CoF₃, MnF₃, FeF₃, TiS₂, TaS₂, MoS₂, NbSe₃, MnO₂, CoO₂, etc.), the anode is preferably prelithiated to at least 40%, and more preferably from 50% to 100%. For a lithiated cathode active material (e.g., lithium transition metal oxides such as NCM and NCA), the anode may be prelithiated to less than 40%.

The inorganic material may be selected from a metal oxide, metal phosphate, metal silicide, metal selenide, transition metal sulfide, sulfur, lithium polysulfide, selenium, lithium selenide, or a combination thereof. In some embodiments, the inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V, Ti, Al, B, Sn, or Bi; and x+y≤1. Examples of the lithium transition metal oxide- or lithium mixed transition metal oxide-based positive active materials include: Li (M′_{X}M″_{Y})O₂, Where M′ and M″ are different metals (e.g., Li(NiXMn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, Where M is a metal, (e.g. Li(Co_{X}Ni_{1-X})O₂ and Li(Co_{X}Fe_{1-X})O₂), Li_{1-W}(Mn_{X}Ni_{Y}Co_{Z})O₂, (e.g. Li(Co_{X}Mn_{Y}Ni_{(1-X-Y)})O₂, Li(Mn_{1/3}Ni_{1/3}Co_{1/3})O₂, Li(Mn_{1/3}Ni_{1/3}Co_{1/3-X}Mg_{X})O₂, Li(Mn_{0.4}Ni_{0.4}Co_{0.2})O₂, Li(Mn_{0.1}Ni_{0.1}Co_{0.8})O₂), Li_{1-W}(Mn_{X}Ni_{X}Co_{1-2X})O₂, Li_{1-W} Mn_{X}Ni_{Y}CoAl_{W})O₂, Li_{1-W} (Ni_{X}Co_{Y}Al_{Z})O₂, where W=0-1, (e.g., Li(Ni_{0.8}Co_{0.15}Al_{0.05})O₂), Li_{1-W}(Ni_{X}Co_{Y}M_{Z})O₂, Where M is a metal, Li_{1-W} (Ni_{X}Mn_{Y}M_{Z})O₂, Where M is a metal, Li(Ni_{X}Mn_{Y}Cr_{2-X})O₄, LiM′M″₂O₄, Where M′ and M″ are different metals (e.g., LiMn_{2-Y-Z} Ni_{Y}O₄, LiMn_{2-Y-Z} Ni_{Y}Li_{Z}O₄, LiMn_{1.5}Ni_{0.5}O₄, LiNiCuO₄, LiMn_{1-X}AL_{X}O₄, LiNi_{0.5}Ti_{0.5}O₄, Li_{1.05}Al_{0.1}Mn_{1.85}O_{4-z}F_{z}, Li₂MnO₃) Li_{X}V_{Y}O_{Z}, e.g. LiV₃O₈, LiV₂O₅, and LiV₆O₁₃.

The metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In certain desired embodiments, the inorganic material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The organic material or polymeric material may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]ₙ), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer is selected from Poly[methanetetryl-tetra(thiomethylene)](PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

The organic material may contain a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The following examples serve to provide the best modes of practice for the present disclosure and should not be construed as limiting the scope of the disclosure:

### Example 1: Preparation of Discrete Graphene Sheets, Expanded Graphite Flakes, and Graphitic Films Therefrom

Natural graphite powder with an average lateral dimension of 45 μm was used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 16 hours of reaction, the acid-treated natural graphite particles were filtered and washed thoroughly with deionized water until the pH level of the solution reached 4.0. After being dried at 100° C. overnight, the resulting graphite intercalation compound (GIC) was subjected to a thermal shock at 1050° C. for 45 seconds in a tube furnace to form exfoliated graphite (or graphite worms). Some graphite worms were recompressed, using press-rolling, into flexible graphite foils.

Five grams of the resulting exfoliated graphite (graphite worms) were mixed with 2,000 ml alcohol solution consisting of alcohol and distilled water with a ratio of 65:35 for 2 hours to obtain a suspension. Then the mixture or suspension was subjected to ultrasonic irradiation with a power of 200 W for various times. After two intermittent sonication treatments each of 1.5 hours, EG particles were effectively fragmented into thin graphene sheets. The suspension was then filtered and dried at 80° C. to remove residue solvents. The as-prepared graphene sheets (thermally reduced GO) have an average thickness of approximately 3.4 nm.

Another five grams of the resulting exfoliated graphite worms were subjected to low-intensity air jet milling to break up graphite worms, forming expanded graphite flakes (having an average thickness of 139 nm).

Both graphene sheets and expanded graphite flakes were then made into film or paper forms using a film-forming procedure described earlier (e.g., as illustrated in FIG. 3(A)) and a standard paper-making procedure, respectively. These graphitic films (flexible graphite foils, graphene film, and expanded graphite paper, etc.) were used as a conductive substrate and/or graphitic layer in the presently disclosed multi-layer anode.

In this example and several examples that follow, the lithium films used were deposited onto a primary surface of a conductive substrate using thermal evaporation or sputtering. In other examples, a pre-made lithium foil (thickness ranging from 5 to 60 μm) is attached to a conductive substrate and covered by a graphitic film, or sandwiched between a conductive substrate and a graphitic film.

### Example 2: Graphene Oxide from Sulfuric Acid Intercalation and Exfoliation of MCMBs and Production of GO-Based Graphene Films

MCMB (meso-carbon microbeads) were supplied by China Steel Chemical Co. This material has a density of about 2.24 g/cm³ with a median particle size of about 16 μm. MCMBs (10 grams) were intercalated with an acid solution (sulfuric acid, nitric acid, and potassium permanganate at a ratio of 4:1:0.05) for 48 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was neutral. The slurry was dried and stored in a vacuum oven at 60° C. for 24 hours. The dried powder sample was placed in a quartz tube and inserted into a horizontal tube furnace pre-set at a desired temperature, 800° C.-1,100° C. for 30-90 seconds to obtain reduced graphene oxide (RGO) sheets. A quantity of graphene sheets was mixed with water and ultrasonicated at 60-W power for 10 minutes to obtain a graphene dispersion.

A small amount was sampled out, dried, and investigated with TEM, which indicated that most of the graphene sheets were between 1 and 10 layers. The oxygen content of the graphene powders (GO or RGO) produced was from 0.1% to approximately 25%, depending upon the exfoliation temperature and time.

Several graphene dispersions were subjected to a slot-die coating procedure to deposit a wet layer of GO sheets, having a thickness of 10-100 m, on PET films. Upon drying, the resulting thin films of reduced graphene oxide (RGO) were subjected to a heat treatment to produce graphene films. The heat treatment conditions were as follows: treating at 300° C. for 2 hours, ramping up temperatures at a rate of 250 degrees/hour, and then heat-treating at 2,850° C. for 1 hour. The resulting graphene films were then roll-pressed until the physical density reached a value from approximately 1.7 to 2.2 g/cm³.

### Example 3: Oxidation and Exfoliation of Natural Graphite to Produce Graphene Oxide (GO) Sheets and GO-Based Graphene Films

Graphite oxide was prepared by oxidation of graphite flakes with sulfuric acid, sodium nitrate, and potassium permanganate at a ratio of 4:1:0.05 at 30° C. for 48 hours, according to the method of Hummers [U.S. Pat. No. 2,798,878, Jul. 9, 1957]. Upon completion of the reaction, the mixture was poured into deionized water and filtered. The sample was then washed with 5% HCl solution to remove most of the sulfate ions and residual salt and then repeatedly rinsed with deionized water until the pH of the filtrate was approximately 4. The intent was to remove all sulfuric and nitric acid residue out of graphite interstices. The slurry was dried and stored in a vacuum oven at 60° C. for 24 hours.

The dried, intercalated (oxidized) compound was exfoliated by placing the sample in a quartz tube that was inserted into a horizontal tube furnace pre-set at 650° C. to obtain highly exfoliated graphite. The exfoliated graphite was dispersed in water along with a 1% surfactant at 45° C. in a flat-bottomed flask and the resulting suspension was subjected to ultrasonication for a period of 15 minutes to obtain dispersion of graphene oxide (GO) sheets.

The dispersion was then coated onto a PET film using a reverse-roll coating procedure to obtain GO films. Upon peeling from PET substrate, the GO films were then placed in a graphite mold and subjected to various heat treatments, having a final heat treatment temperature from 85° C. to 2,900° C. After heat treatments, the films were roll-pressed to reduce the porosity. These graphene films were used as a conductive substrate, a first/second graphitic film, or both.

### Example 4: Preparation of Pristine Graphene Sheets and Graphene Films

Pristine graphene sheets were produced by using the direct ultrasonication or liquid-phase exfoliation process. In a typical procedure, five grams of graphite flakes, ground to approximately 20 m in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets were pristine graphene that had never been oxidized and were oxygen-free and relatively defect-free. Thermal films were prepared from pristine graphene by following the procedure as described in Example 3.

### Examples 5: Preparation of Graphene Fluoride (GF) and GF-Based Graphene Films

Several processes have been used by us to produce GF, but only one process is herein described as an example. In a typical procedure, highly exfoliated graphite (HEG) was prepared from intercalated compound C₂F.xClF₃. HEG was further fluorinated by vapors of chlorine trifluoride to yield fluorinated highly exfoliated graphite (FHEG). A pre-cooled Teflon reactor was filled with 20-30 mL of liquid pre-cooled ClF₃, and then the reactor was closed and cooled to liquid nitrogen temperature. Subsequently, no more than 1 g of HEG was put in a container with holes for ClF₃ gas to access the reactor. After 7-10 days, a gray-beige product with approximate formula C₂F was formed. GF sheets were then dispersed in halogenated solvents to form suspensions. The suspensions were then coated on PET film substrate surfaces using comma coating, dried, peeled off from the substrate, and heat treated at 500° C. for 3 hours and 2750° C. for 1 hour. After heat treatments, the films were then roll-pressed to increase the physical densities to 1.90-2.15 g/cm³.

### Example 6: Preparation of Nitrogenated Graphene and Graphene Films

Graphene oxide (GO), synthesized in Example 3, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene/urea mass ratios of 1/0.5, 1/1 and 1/2 are designated as N-1, N-2 and N-3 respectively and the nitrogen contents of these samples were 14.7, 18.2 and 17.5 wt. % respectively as determined by elemental analysis. These nitrogenated graphene sheets remain dispersible in water. The resulting dispersion was subjected to the compressing/aligning procedure to form graphene thermal films.

### Example 7: Functionalized Graphene-Based Graphene Films

Thermal films were prepared from several functionalized graphene-elastomer dispersions containing 5% by weight of functionalized graphene sheets (few-layer graphene) and 0.01% by weight of urethane oligomer (a mixture of di-isocyanate and polyol). Chemical functional groups involved in this study include an azide compound (2-Azidoethanol), alkyl silane, hydroxyl group, carboxyl group, amine group, sulfonate group (—SO₃H), and diethylenetriamine (DETA). These functionalized graphene sheets were supplied from Taiwan Graphene Co., Taipei, Taiwan. Upon casting of the dispersion, removal of the liquid medium (acetone), compressed with a heated press and cured at 150° C. for 45 minutes, one obtained thermal films wherein graphene sheets were well bonded to urethane based elastomer. The presently invented highly oriented graphene-elastomer composite films can deliver a thermal conductivity as high as 1,255 W/mK. These composite graphene films were used as constituent films in laminated prelithiated anode electrodes.

### Example 8: Preparation of Graphitic Films from Polybenzoxazole (PBO) Films, PBO/Graphene Films, and PBO/Expanded Graphite Flake Films

Polybenzoxazole (PBO) films were prepared via casting and thermal conversion from its precursor, methoxy-containing polyaramide (MeO—PA). Specifically, monomers of 4, 4′-diamino-3,3′-dimethoxydiphenyl (DMOBPA), and isophthaloyl dichloride (IPC) were selected to synthesize PBO precursors, methoxy-containing polyaramide (MeO—PA) solution.

This MeO—PA solution for casting was prepared by polycondensation of DMOBPA and IPC in DMAc solution in the presence of pyridine and LiCl at −5° C. for 2 hr, yielding a 20 wt % pale yellow transparent MeO—PA solution. The inherent viscosity of the resultant MeO—PA solution was 1.20 dL/g measured at a concentration of 0.50 g/dl at 25° C. This MeO—PA solution was diluted to a concentration of 15 wt % by DMAc for casting.

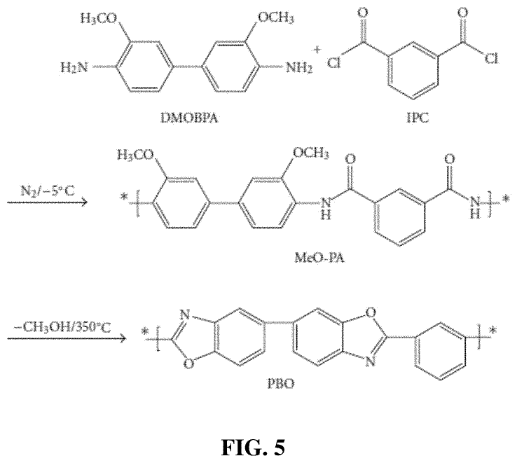

The as-synthesized MeO—PA was cast onto a glass surface to form thin films (35-120 μm) under a shearing condition. The cast film was dried in a vacuum oven at 100° C. for 4 hours to remove the residual solvent. Then, the resulting film with thickness of approximately 28-100 μm was treated at 200° C.-350° C. under N₂ atmosphere in three steps and annealed for about 2 hours at each step. This heat treatment serves to thermally convert MeO—PA into PBO films. The chemical reactions involved may be illustrated in FIG. 5. For comparison, both graphene-reinforced PBO (NGP-PBO) and expanded graphite flake-PBO films were made under similar conditions. The NGP or EP flake proportions, prepared in Example 1, were varied from 0.01% to 50% by weight.

All the films prepared were pressed between two plates of alumina while being heat-treated (carbonized) under a 3-sccm argon gas flow in three steps: from room temperature to 600° C. in 1 h, from 600 to 1,000° C. in 1.5 h, and maintained at 1,000° C. for 1 h. The carbonized films were then roll-pressed in a pair of rollers to reduce the thickness by approximately 40%. The roll-pressed films were then subjected to graphitization treatments at 2,500° C. for 2 hours to produce porous graphitic films. Subsequently, the porous graphitic films were compressed with a heated press.

### Example 9: Preparation of Graphitic Films from Polyimide (PI) Films and Graphene-Reinforced PI Films

The synthesis of conventional polyimide (PI) involved poly(amic acid) (PAA, Sigma Aldrich) formed from pyromellitic dianhydride (PMDA) and oxydianiline (ODA). Prior to use, both chemicals were dried in a vacuum oven at room temperature. Next, as an example, 4 g of the monomer ODA was dissolved into 21 g of DMF solution (99.8 wt %). This solution was stored at 5° C. before use. PMDA (4.4 g) was added, and the mixture was stirred for 30 min using a magnetic bar. Subsequently, the clear and viscous polymer solution was separated into four samples. Triethyl amine catalyst (TEA, Sigma Aldrich) with 0, 1, 3, and 5 wt % was then added into each sample to control the molecular weight. Stirring was maintained by a mechanical stirrer until the entire quantity of TEA was added. The as-synthesized PAA was kept at −5° C. to maintain properties essential for further processing.

Solvents utilized in the poly(amic acid) synthesis play a very important role. Common dipolar aprotic amide solvents utilized are DMF, DMAc, NMP and TMU. DMAc was utilized in the present study. The intermediate poly(amic acid) and graphene/PAA precursor composite were converted to the final polyimide by the thermal imidization route. Graphene sheets used were prepared in Examples 2 and 3. Films were first cast on a glass substrate and then allowed to proceed through a thermal cycle with temperatures ranging from 100° C. to 350° C. The procedure entails heating the poly(amic acid) mixture to 100° C. and holding for one hour, heating from 100° C. to 200° C. and holding for one hour, heating from 200° C. to 300° C. and holding for one hour and slow cooling to room temperature from 300° C.

The PI and graphene-reinforced PI films, pressed between two alumina plates, were heat-treated under a 3-sccm argon gas flow at 1,000° C. This occurred in three steps: from room temperature to 600° C. in 1 h, from 600 to 1,000° C. in 1.3 h, and 1,000° C. maintained for 1 h. The carbonized films were then graphitized at a temperature of 2,780° C. for 1 hour to obtain porous graphitic films. After heat treatments, the films were roll-pressed to increase the physical densities to 1.7-2.05 g/cm³.

### Example 10: Preparation of Graphitic Films Derived from Phenolic Resin Films, Expanded Graphite/Phenolic Resin Films, and Graphene/Phenolic Films

Phenol formaldehyde resins (PF) are synthetic polymers obtained by the reaction of phenol or substituted phenol with formaldehyde. The PF resin, alone or with 25% by weight graphene fluoride sheets (prepared in Example 5) or expanded graphite (EP) flakes (prepared in Example 1), was made into 50-μm thick films and cured under identical curing conditions: a steady isothernal cure temperature at 100° C. for 2 hours and then increased from 100 to 170° C. and maintained at 170° C. to complete the curing reaction.

All the thin films were then carbonized at 500° C. for 2 hours and then at 700° C. for 3 hours. The carbonized films were then subjected to further heat treatments (graphitization) at temperatures that were varied from 2,500 to 2,950° C. for 2 hours.

After heat treatments, the porous graphitic films were roll-pressed to obtain consolidated graphitic films.

### Example 11: Preparation of Graphitic Films from Polybenzimidazole (PBI) Films and Graphene/PBI Films

PBI is prepared by step-growth polymerization from 3,3′,4,4′-tetraaminobiphenyl and diphenyl isophthalate (an ester of isophthalic acid and phenol). The PBI used in the present study was obtained from PBI Performance Products in a PBI solution form, which contains 0.7 dl/g PBI polymer dissolved in dimethylacetamide (DMAc). The PBI and NGP-PBI films were cast onto the surface of a glass substrate. The heat treatment, elastomer resin impregnation, and roll-pressing procedures were similar to those used in Example 8 for PBO.

### Example 12: Graphitic Films from Various Pitch-Based Carbon Precursors

Additional graphitic films were prepared from several different types of precursor materials. Their electric and thermal conductivity values are listed in Table 1 below.

TABLE 1
Preparation conditions and properties of graphitic films from other precursor materials

| | | | Graphitization | | Electric | Thermal |
|---|---|---|---|---|---|---|
| Sample | graphene or | Carbon | temperature | | conduc. | conduc. |
| No. | EP | Precursor | (° C.) | Elastomer/rubber | (S/cm) | (W/mK) |
| 12-A | Pristine | Petroleum | 2,850 | Urea-urethane | 12,300 | 1485 |
| | graphene, 25% | pitch | | copolymer | | |
| 12-B | None | Petroleum | 2,850 | Urea-urethane | 11,850 | 1444 |
| | | pitch | | copolymer | | |
| 12-C | EP, 30% | Petroleum | 2,850 | Urea-urethane | 11,976 | 1466 |
| | | pitch | | copolymer | | |
| 15-A | Reduced GO, | Naphthalene | 2,800 | Polyurethane | 13,322 | 1555 |
| | 35% | | | | | |
| 16-A | Fluorinated | Coal tar | 2,750 | Polyisoprene | 12,022 | 1466 |
| | graphene, 50% | pitch | | | | |
| 16-B | none | Coal tar | 2,750 | SBR | 13,255 | 1550 |
| | | pitch | | | | |

### Example 13: Preparation of Graphene-Based Webs (Paper or Mat of Graphene Sheets and Graphene/CNFs)

Continuous graphite fiber yarns were heated at 800° C. in a nitrogen atmosphere for 5 hours to remove the surface sizing. The yarns were cut into segments of 5 mm long and then ball-milled for 24 hours. The intercalation chemicals used in the present study, including fuming nitric acid (>90%), sulfuric acid (95-98%), potassium chlorate (98%), and hydrochloric acid (37%), were purchased from Sigma-Aldrich and used as received.

A reaction flask containing a magnetic stir bar was charged with sulfuric acid (360 mL) and nitric acid (180 mL) and cooled by immersion in an ice bath. The acid mixture was stirred and allowed to cool for 15 min, and graphite fibers (20 g) were added under vigorous stirring to avoid agglomeration. After the graphite fiber segments were well dispersed, potassium chlorate (110 g) was added slowly over 15 min to avoid sudden increases in temperature. The reaction flask was loosely capped to allow evolution of gas from the reaction mixture, which was stirred for 48 hours at room temperature. On completion of the reaction, the mixture was poured into 8 L of deionized water and filtered. The slurry was spray-dried to recover an expandable graphite fiber sample. The dried, expandable graphite fiber sample was quickly placed in a tube furnace preheated to 1,000° C. and allowed to stay inside a quartz tube for approximately 40 seconds to obtain exfoliated graphite worms. The worms were dispersed in water to form a suspension, which was ultrasonicated with a power of 60 watts for 15 minutes to obtain separated NGPs.

Approximately half of the NGP-containing suspension was filtered and dried to obtain several paper-like mats, referred to as Sample NGP-100. Vapor grown carbon nano-fibers (CNFs) were then added to the remaining half to form a suspension containing both NGPs and CNFs (20%), which was dried and made into several paper-like mats (Sample NGP-CNF-20). Approximately 5% phenolic resin binder was used to help consolidate the web structures in both samples. Such a web can be used as a conductive substrate or a graphitic layer to support Li for the anode.

### Example 14: Preparation of Conductive Web (Paper or Mat) from Carbon Nano-Tubes (CNTs) and Vapor-Grown CNFs

Commercially available CNTs (Cheap Tubes, LLC) and vapor-grown CNFs (Applied Science, Inc., Cedarville, Ohio) were separately made into conductive webs using a conventional paper-making procedure. Basically, a slurry of CNTs or CNFs was poured over a top surface of a Teflon-based membrane with sub-micron pores. Water permeates through the membrane pores with the assistance of a suction force created by a vacuum pump-generated pressure differential between the top surface and the bottom surface of the membrane. Solid ingredients (CNTs or CNFs) stay on the top surface of the membrane, which may be separated from the membrane and dried to become a sheet of porous paper or mat (Sample CNT and Sample CNF).

### Example 15: Prelithiated Cobalt Oxide (CO₃O₄) Anode

An appropriate amount of inorganic salts Co(NO₃)₂.6H₂O and ammonia solution (NH₃.H₂O, 25 wt. %) were mixed together. The resulting suspension was stirred for 2 hours under an argon flow to ensure a complete reaction. The obtained Co(OH)₂ precursor suspension was calcined at 450° C. in air for 2 h to form particles of the layered CO₃O₄. Portion of the CO₃O₄ particles was then encapsulated with a phenolic resin, which was then carbonized at 500° C. for 2 hours and 900° C. for another 2 hours to obtain carbon-coated CO₃O₄ particles.

Several anode electrodes were prepared by mixing 85 wt. % active material (carbon-protected or non-protected particulates of CO₃O₄), 7 wt. % graphite particles, and 8 wt. % polyvinylidene fluoride (PVDF) binder dissolved in N-methyl-2-pyrrolidinoe (NMP) to form a slurry containing 5 wt. % total solid content. The slurries were then separately coated on a primary surface of a graphitic layer, which was in turn pre-attached to a thin film of lithium metal supported on a conductive substrate (a Cu foil or a graphitic layer). After coating, the electrodes were dried at 120° C. in vacuum for 2 h to remove the solvent.

Then, the electrodes were cut into a disk (ϕ=12 mm) and dried at 100° C. for 24 h in vacuum. Electrochemical measurements were carried out using CR2032 (3V) coin-type cells with a LiCoO₂ cathode, Celgard 2400 membrane as a separator, and 1 M LiPF₆ electrolyte solution dissolved in a mixture of ethylene carbonate (EC) and diethyl carbonate (DEC) (EC-DEC, 1:1 v/v). The cell assembling procedure was performed in an argon-filled glove-box. The CV measurements were carried out using an electrochemical workstation at a scanning rate of 1 mV/s.

The electrochemical performance of the prelithiated Co₃O₄-based anodes and that of non-prelithiated CO₃O₄ anodes were evaluated by galvanostatic charge/discharge cycling at a current density of 50 mA/g, using an electrochemical workstation.

In general, the prelithiated anodes exhibit a significantly higher first-cycle efficiency (lower initial capacity loss). The initial capacity loss likely has resulted mainly from the formation of solid electrolyte interface (SEI) layers on the surfaces of anode active material particles and some lithium ions being trapped inside the defects of the anode active materials. The prelithiated anode with a thin layer of lithium metal is capable of compensating for the lithium loss.

### Example 16: Prelithiated Anode of Tin Oxide Particles

Tin oxide (SnO₂) nano particles were obtained by the controlled hydrolysis of SnCl₄.5H₂O with NaOH using the following procedure: SnCl₄.5H₂O (0.95 g, 2.7 m-mol) and NaOH (0.212 g, 5.3 m-mol) were dissolved in 50 mL of distilled water each. The NaOH solution was added drop-wise under vigorous stirring to the tin chloride solution at a rate of 1 mL/min. This solution was homogenized by sonication for 5 m in. Subsequently, the resulting hydrosol was reacted with H₂SO₄. To this mixed solution, few drops of 0.1 M of H₂SO₄ were added to flocculate the product. The precipitated solid was collected by centrifugation, washed with water and ethanol, and dried in vacuum. The dried product was heat-treated at 400° C. for 2 h under Ar atmosphere to obtain SnO₂ nano particles.

Several anode active layers were prepared by mixing 85 wt. % active material (SnO₂ nano particles), 7 wt. % super-P particles, and 8 wt. % polyacrylic acid binder to form a slurry in water. The slurry was coated on a graphitic film surface and dried to produce a pre-fabricated anode active layer supported on a graphitic layer. Separately, a thin film of lithium metal was deposited onto a surface of another graphitic layer (as a conductive substrate) to form a Li-coated conductive substrate. This coated substrate is then combined with the graphitic layer-supported anode active layer, with the lithium metal being covered by the graphitic layer, to for a prelithiated anode electrode (totally 4 layers). These anodes were paired up with several different cathode layers to prepare lithium-ion cells. These cathodes were based on the well-known NCM-532, NCA, and LFP particles, respectively.

### Example 17: Prelithiated Anodes Including Silicon (Si) Particles

Sub-micron sized Si particles were encapsulated with a thin layer of phenolic resin shell and graphene sheets via the spray-drying method, followed by a heat treatment from 350-600° C. for 4 hours to obtain graphene-protected, carbon-coated Si particles. A portion of these C-coated Si particles was combined with 10% acetylene black (a conductive additive), and a CMC binder resin to form a pre-fabricated anode active layer bonded to a graphitic layer using the slurry coating procedure.

On a separate basis, a thin layer of lithium metal film was attached to a surface of a conductive substrate (a graphene-based graphitic film and a Cu foil, respectively) to form a conductive substrate-supported Li metal structure. This structure was then combined with a pre-fabricated anode active layer (bonded on a graphitic layer) to form a 4-layer structure, a “prelithiated multi-layer anode”.

This 4-layer structure (consisting of a Cu foil or graphene film, a Li metal layer, a graphitic film, and a Si-based active material layer) was then immersed in a lithium salt solution containing LiPF₆ salt dissolved in EC-PC (50/50) as an electrolyte solution. This creates an electrically shorting condition, allowing lithium ions to gradually diffuse into the bulk of Si particles. Typically, a degree of prelithiation of 80-100% was obtained. These Si-rich anodes, upon prelithiation, were used to pair up with initially lithium-free cathode materials (e.g., FeF₃, CuF₂, and MoS₂) for forming high-energy lithium-ion cells.

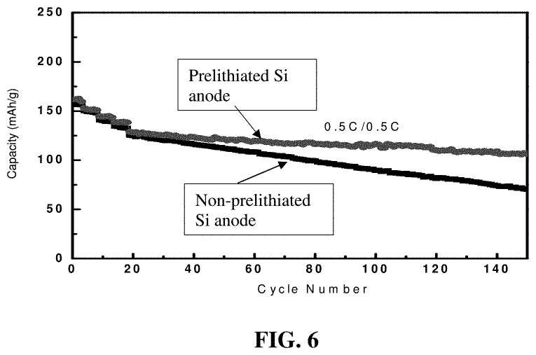

Additionally, two battery cells were prepared, each containing an NCM-523 cathode and a Si-based anode (one prelithiated and the other not). The results, summarized in FIG. 6, have clearly demonstrated that the strategy of prelithiation leads to a lithium-ion cell having a significantly improved cycling stability.

### Example 18: Prelithiated Anodes of Si Nanowire-Based Anode Materials

Si nanowires, having a diameter range from 19 to 28 nm, were supplied from Angstron Energy Co. (Dayton, Ohio). Some Si nanowires were coated with a layer of graphene sheets using spray-drying of Si nanowire/graphene oxide/water suspension. The graphene-coated Si nanowires, along with carbon nanotubes (CNTs) and 5% polyacrylic acid binder, were then coated onto the top surface of a three-layer structure (Cu foil-Li metal-graphitic film) to form a prelithiated anode.

### Example 19: Lithium Battery Containing Prelithiated Si Anode and a Cathode Containing V₂O₅ Particles

Cathode active material layers were prepared from V₂O₅ particles and graphene-embraced V₂O₅ particles, respectively. The V₂O₅ particles were commercially available. Graphene-embraced V₂O₅ particles were prepared in-house. In a typical experiment, vanadium pentoxide gels were obtained by mixing V₂O₅ in a LiCl aqueous solution. The Li⁺-exchanged gels obtained by interaction with LiCl solution (the Li:V molar ratio was kept as 1:1) was mixed with a GO suspension and then placed in a Teflon-lined stainless steel 35 ml autoclave, sealed, and heated up to 180° C. for 12 h. After such a hydrothermal treatment, the green solids were collected, thoroughly washed, ultrasonicated for 2 minutes, and dried at 70° C. for 12 h followed by mixing with another 0.1% GO in water, ultrasonicating to break down nano-belt sizes, and then spray-drying at 200° C. to obtain graphene-embraced V₂O₅ composite particulates. Selected amounts of V₂O₅ particles and graphene-embraced V₂O₅ particles, respectively, were then each made into a cathode layer following a well-known slurry coating process.

For electrochemical testing, the working electrodes (cathode layers) were prepared by mixing 85 wt. % V₂O₅ or 88% of graphene-embraced V₂O₅ particles, 5-8 wt. % CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were carried out using CR2032 (3V) coin-type cells each including a prelithiated anode electrode (prepared in Example 17), Celgard 2400 membrane as a separator, and 1 M LiPF₆ electrolyte solution dissolved in a mixture of ethylene carbonate (EC) and diethyl carbonate (DEC) (EC-DEC, 1:1 v/v). The cell assembly was performed in an argon-filled glove-box. The CV measurements were carried out using a CH-6 electrochemical workstation at a scanning rate of 1 mV/s. The electrochemical performance of the cell featuring a prelithiated Si anode was evaluated by galvanostatic charge/discharge cycling at a current density of 50 mA/g using an Arbin electrochemical workstation.

### Example 20: High-Energy Density Lithium-Ion Cells Containing Metal Fluoride Nano Particle-Based Cathode and a Prelithiated Si Anode

Commercially available powders of CoF₃, MnF₃, FeF₃, VF₃, VOF₃, TiF₃, and BiF₃ were subjected to high-intensity ball-milling to reduce the particle size down to approximately 0.5-2.3 μm. Each type of these metal fluoride particles, along with graphene sheets (as a conductive additive), was then added into an NMP and PVDF binder suspension to form a multiple-component slurry. The slurry was then slurry-coated on Al foil to form cathode layers. A cathode layer, a separator, and a prelithiated anode layer prepared in Example 17 were then combined to form a lithium-ion cell.

### Example 21: Li—S Cells Containing a Fully Prelithiated Si Anode and a Cathode Containing Sulfur-Impregnated Activated Carbon Particles

One way to combine sulfur with a conducting material (e.g., carbon/graphite particles) is to use a solution or melt mixing process. Highly porous activated carbon particles, chemically etched meso-carbon micro-balls (activated MCMBs), and exfoliated graphite worms were mixed with sulfur melt at 117-120° C. (slightly above the melting point of S, 115.2° C.) for 10-60 minutes to obtain sulfur-impregnated carbon particles. Since the cathode active material, S, does not contain any lithium, the anode must be a lithiated material; herein a fully prelithiated Si anode prepared in Example 17 was used.

1. A multi-layer prelithiated anode for a lithium-ion cell, said anode comprising:
a) a conducting substrate having a first primary surface and a second primary surface;
b) a first layer of lithium metal deposited onto or attached to the first primary surface of the conducting substrate;
c) a first graphitic layer that substantially covers the first lithium metal layer; and
d) a first anode active layer deposited on a primary surface of the first graphitic layer, wherein the first anode active layer includes an anode active material.

2. The multi-layer prelithiated anode of claim 1, wherein the first anode active layer includes multiple particles of an anode active material and a first binder that holds the multiple anode material particles together to form the first anode active layer.

3. The multi-layer prelithiated anode of claim 2, wherein the first anode active layer also includes a conductive additive and said first binder holds the multiple anode material particles and the conductive additive together to form the first anode active layer.

4. The multi-layer prelithiated anode of claim 1, wherein the first anode active layer includes a film including the anode active material.

5. The multi-layer prelithiated anode of claim 1, wherein the anode active material is selected from the group consisting of: (a) silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium niobate, lithium transition metal oxide; (f) carbon or graphite particles; and (g) combinations thereof.

6. The multi-layer prelithiated anode of claim 1, wherein the anode active material is selected from silicon (Si), germanium (Ge), phosphorus (P), tin (Sn), SiOx (0<x<2.0), SnO₂, or a combination thereof.

7. The multi-layer prelithiated anode of claim 1, wherein the first graphitic film includes a film, paper, or fabric layer of a graphene material, expanded graphite, recompressed exfoliated graphite, highly oriented pyrolytic graphite, polymer- or pitch-derived graphite, carbon nanotubes, carbon nano-fibers, carbon or graphite fibers, graphitic carbon, amorphous carbon, or a combination thereof.

8. The multi-layer prelithiated anode of claim 7, wherein the graphene material includes a material selected from pristine graphene, graphene oxide, reduced graphene oxide, graphene fluoride, graphene chloride, graphene bromide, graphene iodide, nitrogenated graphene, hydrogenated graphene, functionalized graphene, doped graphene, or a combination thereof.

9. The multi-layer prelithiated anode of claim 1, wherein the conducting substrate is selected from a solid metal film, a porous metal film, a graphitic film, or a combination thereof wherein the graphitic film includes a film, paper, or fabric of a graphene material, expanded graphite, recompressed exfoliated graphite, highly oriented pyrolytic graphite, polymer- or pitch-derived graphite, carbon nanotubes, carbon nano-fibers, carbon or graphite fibers, graphitic carbon, amorphous carbon, or a combination thereof.

10. The multi-layer prelithiated anode of claim 1, wherein the conducting substrate includes a thin film, paper, or fabric layer of a graphene material or a composite material including sheets of a graphene material dispersed in a polymer or metal matrix, wherein the graphene material is selected from pristine graphene, graphene oxide, reduced graphene oxide, graphene fluoride, graphene chloride, graphene bromide, graphene iodide, nitrogenated graphene, hydrogenated graphene, functionalized graphene, doped graphene, or a combination thereof.

11. The multi-layer prelithiated anode of claim 1, wherein the conducting substrate includes a thin solid film or porous layer of copper (Cu), nickel (Ni), or stainless steel having a thickness from 1 to 50 μm.

12. The multi-layer prelithiated anode of claim 1, further including (e) a second layer of lithium metal deposited onto the second primary surface of the conducting substrate; (f) a second graphitic layer that substantially covers the second lithium metal layer; and (g) a second anode active layer deposited on a primary surface of the second graphitic layer.

13. The multi-layer prelithiated anode of claim 1, wherein the first lithium metal layer contains a lithium amount sufficient to prelithiated the anode to a level of lithium interaction from 5% to 100% of the maximum lithium storage capacity in the anode active material.

14. The multi-layer prelithiated anode of claim 1, wherein the first lithium metal layer has a thickness from 10 nm to 100 μm.

15. The multi-layer prelithiated anode of claim 1, wherein the conductive substrate has a thickness from 1 to 50 μm.

16. The multi-layer prelithiated anode of claim 1, wherein the first graphitic layer has a thickness from 10 nm to 50 μm.

17. A lithium-ion cell that includes the multi-layer prelithiated anode of claim 1, a cathode, a separator that electrically isolates the anode from the cathode, and an electrolyte in ionic communication with the anode and the cathode.

18. The lithium-ion cell of claim 17, wherein said cathode active material is selected from an inorganic material, an organic material, a polymeric material, or a combination thereof.

19. The lithium-ion cell of claim 18, wherein said inorganic material is selected from a metal oxide, metal phosphate, metal silicide, metal selenide, transition metal sulfide, sulfur, lithium polysulfide, selenium, lithium selenide, or a combination thereof.

20. The lithium-ion cell of claim 18, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

21. The lithium-ion cell of claim 18, wherein said inorganic material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof.

22. The lithium-ion cell of claim 18, wherein said inorganic material is selected from a lithium transition metal silicate, denoted as Li₂MSiO₄ or Li₂MaₓMb_{y}SiO₄, wherein M and Ma are selected from Fe, Mn, Co, Ni, or V; Mb is selected from Fe, Mn, Co, Ni, V, Ti, Al, B, Sn, or Bi; and x+y≤1.

23. The lithium-ion cell of claim 18, wherein said inorganic material is selected from a transition metal dichalcogenide, a transition metal trichalcogenide, or a combination thereof.

24. The lithium-ion cell of claim 18, wherein said inorganic material is selected from TiS₂, TaS₂, MoS₂, NbSe₃, MnO₂, CoO₂, an iron oxide, a vanadium oxide, or a combination thereof.

25. The lithium-ion cell of claim 18, wherein said metal oxide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

26. The lithium-ion cell of claim 18, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

27. The lithium-ion cell of claim 18, wherein said inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

28. The lithium-ion cell of claim 18, wherein said organic material or polymeric material is selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]ₙ), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

29. The lithium-ion cell of claim 28, wherein said thioether polymer is selected from Poly[methanetetryl-tetra(thiomethylene)] (PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene](PTKPTB, or poly[3,4(ethylenedithio)thiophene] (PEDTT).

30. The lithium-ion cell of claim 18, wherein said organic material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

31. The lithium-ion cell of claim 17, wherein the anode includes Si that is prelithiated to approximately 60-100% and wherein the cathode includes a cathode active material that is initially lithium-free when the cell is made.

32. A method of producing the multi-layer prelithiated anode of claim 1, said method including: (A) providing a conducting substrate having a first primary surface and a second primary surface; (B) depositing a first layer of lithium metal onto the first primary surface of the conducting substrate; (C) depositing or attaching a first graphitic layer onto the first lithium metal layer wherein the first graphitic layer substantially covers the first lithium metal layer; and (D) depositing a first anode active layer on a primary surface of the first graphitic layer, wherein the first anode active layer includes an anode active material.

33. The method of claim 32, wherein the method is conducted in a roll-to-roll manner.

34. The method of claim 32, wherein step (B) includes a procedure selected from physical vapor deposition, chemical vapor deposition, sputtering, electrochemical deposition or plating, laser ablation-assisted deposition, plasma deposition, powder spraying of lithium, attaching a lithium foil, or a combination thereof.

35. The method of claim 32, wherein step (C) includes a procedure selected from spraying, casting, coating, printing, laminating, or a combination thereof.

36. The method of claim 32, wherein step (D) includes a procedure selected from spraying, casting, coating, printing, laminating, physical vapor deposition, chemical vapor deposition, sputtering, electrochemical deposition or plating, laser ablation-assisted deposition, plasma deposition, or a combination thereof.

37. The method of claim 32, wherein step (D) is conducted prior to step (C).
